(19) United States
(12) Patent Application Publication
(10) Pub. No.: US 2011/0048580 A1
(43) Pub. Date: Mar. 3, 2011

(54) Single cylinder hydraulic log lifter

(76) Inventor: Norman A. Hicks, Coudersport, PA (US)

(21) Appl. No.: 12/584,270

(22) Filed: Sep. 3, 2009

(51) Int. Cl. B27L 7/00; B27B 31/00; B25H 1/00

(52) U.S. Cl. 144/193.1; 144/250.25; 144/286.1

(57) ABSTRACT

This invention adds a very large (24×32 inch or larger) log table permanently mounted to the log splitter. This alone adds immeasurably to the efficiency and convenience of splitting. It allows for the true, convenient, and safe one-man operation of a splitter because it catches and stores the far side of the log and log pieces while the operator is free to handle the near side with one hand and the control valve with the other hand. The log lifter is powered hydraulically with the same cylinder, control valve, hoses and fittings that power the split wedge. Very simply, a cable and a pulley are used to direct the force of the existing cylinder to raise the log lifter. This simplicity lowers the cost of the log lifter considerably and makes it and the log table and the convenience of splitting in a more comfortable, standing position more readily available to the splitting public.

### CROSS-REFERENCE TO RELATED APPLICATIONS

Not applicable

### STATEMENT REGARDING FEDERALLY SPONSORED RESEARCH OR DEVELOPMENT

Not applicable

### TO SEQUENCE LISTING, A TABLE, OR A COMPUTER PROGRAM LISTING COMPACT DISC APPENDIX

Not applicable

### BACKGROUND OF THE INVENTION

Mechanical log splitters of various types have been available for many years. Hydraulically operated ones have become the most commonly used type now.

The larger gasoline powered log splitters available today are capable of splitting logs heavier than the operators can or care to lift. Many splitters can be converted to the vertical position to split these larger logs. This requires the operator to either work in a very bent over position or to get down on his knees which curtails his mobility. A much more convenient method of splitting most large logs is to use a log lifter to raise the logs to the splitter beam where the hydraulically powered split wedge can split them to finished size.

Hydraulically powered log lifters are an expensive but very handy option on many commercially available splitters. They have the advantage of staying right where the operator puts them so they can be used as an auxiliary log table. They can easily raise very large logs with the touch of a finger. Their only real drawback is their high cost. They require a separate cylinder, control valve, hoses, and fittings, all of which add to their cost.

One company makes a manually operated log lifter, but it appears that two people are required to operate it. One person stands at the end of the long lever that raises the log while another person would be required to catch the log and position it on the splitter beam. No provision on that machine is made to catch the far side of the split log unless the second person continues to assist the operator.

Another standard shortcoming in modern log splitters is the lack of a decent sized log table. In the last few years many manufacturers have started adding very small metal pieces to “catch” the far side of the log being split. These are an improvement though a bigger table would be much more useful and safe.

### A BRIEF SUMMARY OF THE INVENTION

The invention consists of a log splitter equipped with a log lifter attached to a large log table in a hinged fashion, and being raised hydraulically by the same cylinder that powers the split wedge. This eliminates the need for a second cylinder, second control valve, and extra hoses and fittings normally required for a log lifter, thereby considerably reducing the overall costs of having a log lifter available for those large logs. A cable attached to the log lifter, runs up over a pulley fixed to the beam and thence to the top, rear end of the split wedge. The operator places the log on the log lifter, then attaches the cable to the split wedge, then powers the split wedge forward using the control valve, and the log is raised. The log rolls to the table and the operator moves it wholly onto the table. Then he returns the split wedge to its retruded position, unhooks the cable from the split wedge, and sets it aside. This only requires a few seconds. He then proceeds to split the log in normal fashion. An added extra is that the log table is permanently available to hold the pieces of the large log until they can be split down to final size.

### BRIEF DESCRIPTION OF THE SEVERAL VIEWS OF THE DRAWING

FIG. 1 shows a side view of the log splitter with the lifter in the down position and loaded with a large log.

FIG. 2 shows a top view of the splitter, table, and log lifter.

FIG. 3 shows an end view for the splitter, table, and lifter.

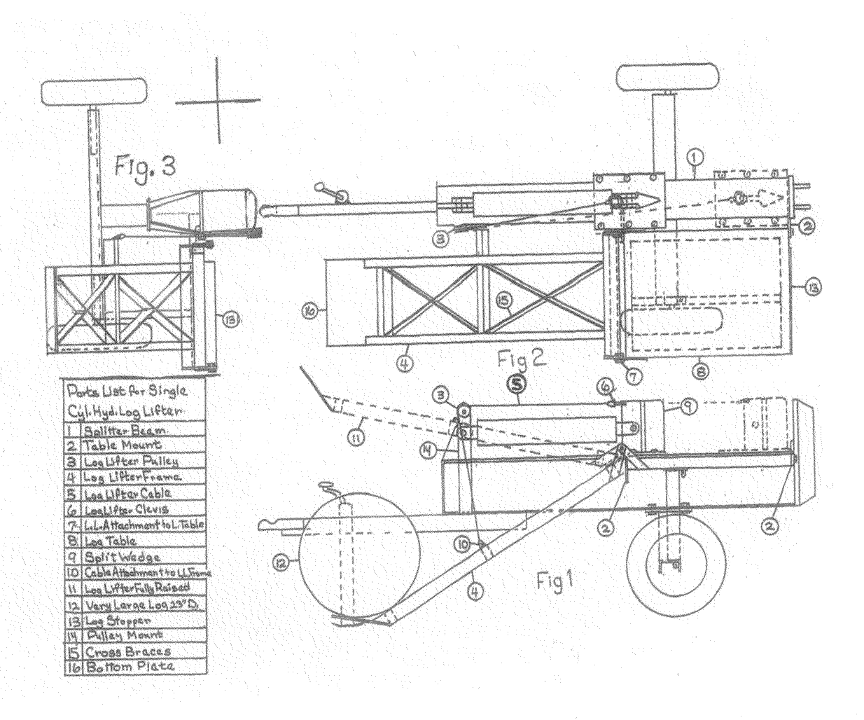

### DETAILED DESCRIPTION OF THE LOG LIFTER

Since this invention is an addition to a log splitter, it is assumed that the splitter is a 22 ton horizontal only splitter with a separate tank, not part of the axle. (Although the vertical/horizontal model would be modified in just the same way except that an extra trailer jack might have to be added to the table to prevent the splitter from tipping if the table would be overloaded.) The log table (No. 8) is added to the splitter first. A piece of 7⅝×2×¼ inch steel flat, with a ½ inch hole centered 1 inch in from the end, is welded to the backstop (No. 2) and underside of the top plate of the beam. Another piece ¼×5×7⅝ inch (No. 2 at the hinge end) and notched to avoid the underside of the split wedge and with a ½ inch hole in the appropriate place to attach to the table, is welded to the underside of the beam and to the web, far enough back toward the base end of the cylinder to allow the table and its mounting brackets to fit in between the two beam mounted brackets.

The table frame (No. 8) is made of rectangular tubing (2½×1½ inch×14 ga.), the corners are mitered then welded together to seal the frame. A brace of similar tubing is added to allow attachment to the table leg. A top is cut from 10 ga. mild steel and welded to the frame. The leg is cut from 2½×1½×14 ga. tubing and welded to the axle or to the combination hydraulic fluid tank/axle. A piece of 1½×4× 3/16 inch is welded to the top of the leg with an 11/16 inch hole drilled into it to match the rod in the bottom brace of the table. Two hinge pieces 7⅝×2×¼ inch flat with ⅝ holes centered 1 7/16 inch from their rounded ends are welded on both sides of the cylinder end of the table. These will attach to the log lifter. They are placed on at a 45 degree angle.

The log lifter starts with a frame (No. 4) of 2½×1½×14 ga. rectangular tubing. Butt joints are used here. The bottom two cross pieces of tubing are cut to 13 inches long with square ends and welded into place. The upper cross tube is cut to 23⅜ inch long. 10 ga. end caps are welded on and then this cross piece is centered on the lifter frame and welded in place. The hinge pieces just like those on the log table are welded to the ends of this cross piece at a 45 degree angle. A 3×3⅜ inch×10 ga. top plate is then added to the table end to dose the gap between the lifter and the log table.

The lower end foot plate (No. 16) ⅛×12×16 inches mild steel plate is then welded onto the sharply angled ends of the long tubings. Then a 5 inch length of the same tubing is welded to the splitter side of the lifter 27½ inches down from the top cross piece of tubing. An end cap (No. 10) can be made of 10 ga. material to the same dimensions as the tubing and be welded into place and a loop of 3/16 D. steel HR rod can be welded to it to hold the cable.

Next the pulley holder (No. 14) has to be welded to the beam. Either a pulley block or a mounted pulley can be used. The plans show a solidly mounted pulley with a small rod to keep the cable in place. Start with a ⅜×2½ inch HR flat piece long enough to reach from the bottom of the beam to just over the top on the split wedge, 21 inches in this plan. How to locate its position? Simply swing the log lifter up (No. 11) to where the cable from the mounting bracket on the log lifter would go smoothly over the pulley and towards the split wedge. This pulley mount needs to be bent twice and it may be easier to tack it to the splitter beam first, then heat it just above the top plate of the beam and then bend the upper end inward toward the cylinder until it is straight up. Allow it to cool and harden. Then heat a larger area above the beam and twist the upper portion of this mount to where it lines up with a little forward of the front edge of the split wedge (No. 9). This will allow the cable to track well. Then add the pulley (No. 3) and some system for holding the cable in place such as a small threaded rod screwed into a hole slightly above the pulley. Drill a small hole in the top rear of the split wedge to accommodate a clevis hitch (No. 6).

Lastly the cable (No. 5) is attached. It can be permanently attached to the lifter or attached with a snap. Then it is brought up over the pulley and is attached loosely to the split wedge Bevis with a snap. If the split wedge travels forward 24 inches the lifter will raise 24 inches at the point of attachment. So the location of the log lifter attachment is critical. The lifter (No. 11) should never be more than slightly above level. One does not want a very large, heavy log to be rolling out of control, falling off, damaging things.

Ideally the split wedge (No. 9) reaches the end of its travel the log lifter frame will be just high enough above level to allow the log to roll gently to the log table where the operator can easily reach it from his normal operating position and bring it full onto the log table. Once he has lowered the log lifter and disconnected the cable, he will position the log for splitting. As he splits this large log into smaller pieces, the extra pieces can remain on the log table until they can be split into their final size. The log table itself becomes a very important part of the splitter.

A log splitter with a 20 inch travel would require a cable attachment closer to the point of rotation (the hinge) to lift the log lifter the same distance. Conversely, a splitter with a 30 inch or larger travel would work better with an attachment farther from the hinge point.

1. This invention allows a log lifter to be lifted via hydraulic power without having to add an extra cylinder, control valve, or hoses and fittings.

2. This log lifter can be added to a log splitter at considerably less cost than a conventional, hydraulically powered lifter.

3. The permanently attached log table allows for true, one-man operation because the operator now is free to keep one hand on the control lever and the other hand is free to control near piece of the log, while the large log table takes care of the far piece or pieces of wood.

4. The large permanently attached log table considerably improves the safety of the operation because it allows the operator to be in control of both the wood and the control lever at the same time.

5. The log table portion of this invention makes the splitter more efficient than most other log splitters because it allows so much wood to be stored within the operator's easy reach, either large split portions of a very large log being split, or several smaller logs stacked there at one time for splitting.
